(19) United States
(12) Patent Application Publication
(10) Pub. No.: US 2006/0046023 A1
(43) Pub. Date: Mar. 2, 2006

(54) Border doormat

(76) Inventor: James Augustus Clewell, Lindale, GA (US)

Correspondence Address: TROUTMAN SANDERS LLP, 600 PEACHTREE STREET , NE, ATLANTA, GA, 30308, US

(21) Appl. No.: 10/930,333

(22) Filed: Aug. 31, 2004

(51) Int. Cl. B32B 3/10

(52) U.S. Cl. 428/131

(57) ABSTRACT

A border mat for supporting and bordering an interchangeable doormat, the border mat comprising a support member having a base, a surface and a periphery. A first area is carried by the surface of the support member, the first area extending around the periphery of the support member. A second area is also carried by the surface of the support member and bordered by the first area, the second area adapted for receiving an interchangeable doormat. A plurality of drainage conduits are provided, each of the drainage conduits having a periphery and defining drainage holes from the second area through the base, wherein fluid may drain from said second area. The border mat may also have indicia on its surface, wherein the first area has a first indicia thereon, and the second area has a second indicia thereon. The second indicia may be the same as the first indicia.

### BACKGROUND OF THE INVENTION

1. Field of the Invention

The present invention relates generally to doormats and, more particularly, to border doormats for outdoor use.

2. Description of the Related Art

Doormats are commonly found at the entrance of a dwelling so that a person may wipe their feet prior to entering. Accordingly, doormats are often used on porches of houses, and at the entrances of businesses, hospitals, schools, hotels, offices, and the like, to prevent dust, dirt, or water from being tracked indoors on the soles of shoes. Such mats typically have an abrasive surface in order to effectively fulfill their purpose. In addition to preventing the tracking of dirt into a dwelling, doormats often serve a decorative purpose as well. For example, doormats are known to have various colors, pictures, logos, and/or writing thereon. As the decorative appeal of doormats has increased in popularity, the demand for doormats with aesthetic, as well as, functional qualities has greatly increased. Accordingly, manufacturers have endeavored to design doormats that have decorative appeal while maintaining functional value in order to meet this high demand.

One such doormat is the framer or border mat. As the name implies, border mats have a raised border around the perimeter of the doormat that surrounds a recessed surface area in the middle of the doormat. Typically, border mats are designed to receive another smaller and interchangeable or replaceable doormat in this recessed surface area. If the interchangeable mat wears out, or if the owner simply tires of the design, the interchangeable mat can be removed and a newer, or different, mat can be replaced within the larger border mat. In fact, the smaller, replaceable mats often have designs on their surface that reflect the months of the year, the seasons, holiday themes, and/or other decorative designs so that consumers will purchase them for use with their border mat. Accordingly, border mats are very popular because they offer the feature of interchangeability.

Although border mats are useful for their intended purpose, they are not without limitations. The recessed surface area has the unfortunate side effect of providing a convenient basin for the collection of moisture, dirt, and debris. As such, water or moisture typically pools in this area and can ruin the smaller interchangeable mats. If the interchangeable mat is made of foam, fabric, or carpet materials, the interchangeable mat may soak up this pooled water like a sponge. When this happens, the doormat may actually transmit mud and water to the soles of shoes rather than removing them, thereby destroying the functionality of the doormat. An ideal environment is also provided for the growth of mold and mildew requiring replacement of the interchangeable mat sooner than would ordinarily be expected. Finally, if the border mat is used in colder climates, the pooled water may freeze and cause damage to both the interchangeable mat and the border mat itself.

What is needed then is border mat which provides the convenience of interchangeability while maintaining the functionality of the doormat. It is to such a device that the present invention is directed.

### SUMMARY OF THE INVENTION

A border mat for supporting and bordering a replaceable doormat, the border mat comprising a support member having a base, a surface and a periphery. A first area is carried by the surface of the support member, the first area extending around the periphery of the support member. A second area is also carried by the surface of the support member and bordered by the first area, the second area adapted for receiving an interchangeable doormat. A plurality of drainage conduits are provided within the second area, each of the drainage conduits having a periphery and defining drainage holes from the second area through the base of the support member, wherein moisture is removed from the second area and away from an interchangeable doormat.

The border mat may also have indicia on its surface, wherein the first area has a first indicia thereon, and the second area has a second indicia thereon. The second indicia may be the same as the first indicia. Such indicia may include raised three dimensional patterns.

### BRIEF DESCRIPTION OF THE FIGURES

FIG. 1 is a perspective view of a preferred embodiment of the present invention.

FIG. 2 is a top view of the preferred embodiment in FIG. 1 without an interchangeable doormat.

FIG. 3 is a top view of the preferred embodiment in FIG. 1 with an interchangeable doormat.

FIG. 4 is a cross sectional view of the preferred embodiment in FIG. 3.

### DETAILED DESCRIPTION OF THE PREFERRED EMBODIMENTS

A preferred embodiment of the invention is a border mat having a support area with a raised first area extending around the periphery of the support area. A recessed second area is also carried by the surface of the support member and bordered by the first area. The recessed second area is adapted for receiving a replaceable doormat. A plurality of drainage conduits are provided within the second area forming drainage holes from the second area through the base of the border mat, thereby preventing water or moisture from building up within the recessed second area and being absorbed by the interchangeable doormat.

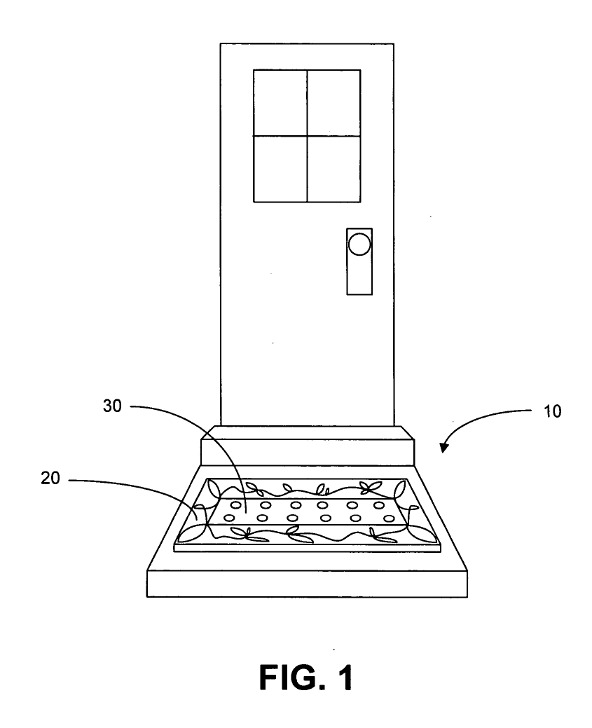

Referring now in detail to the drawing figures, wherein like reference numerals represent like parts, FIG. 1 illustrates a perspective view of a preferred embodiment of the present invention. As seen in FIG. 1, an ornamental border mat 10 is placed on the porch of a dwelling. The surface of the border mat has a first area 20 that extends around the periphery of the border mat and a second area 30 for receiving a replaceable doormat (not shown). The border mat provides an opportunity to wipe one's feet before entering the dwelling and adds a decorative appearance to the porch.

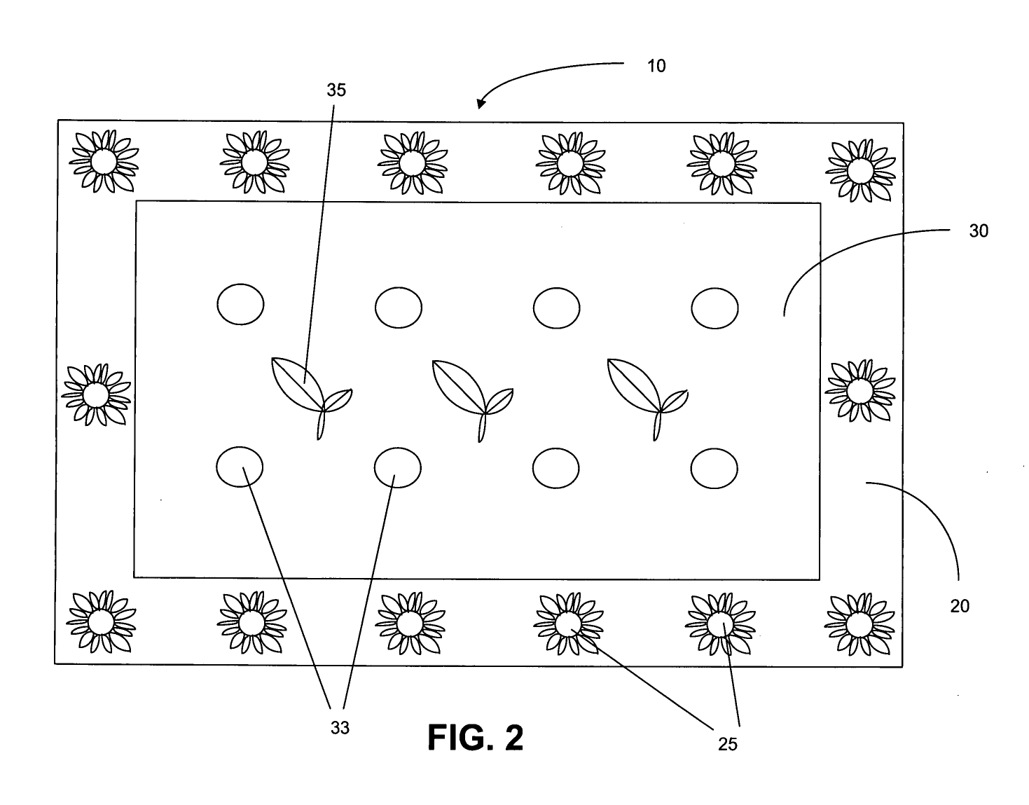

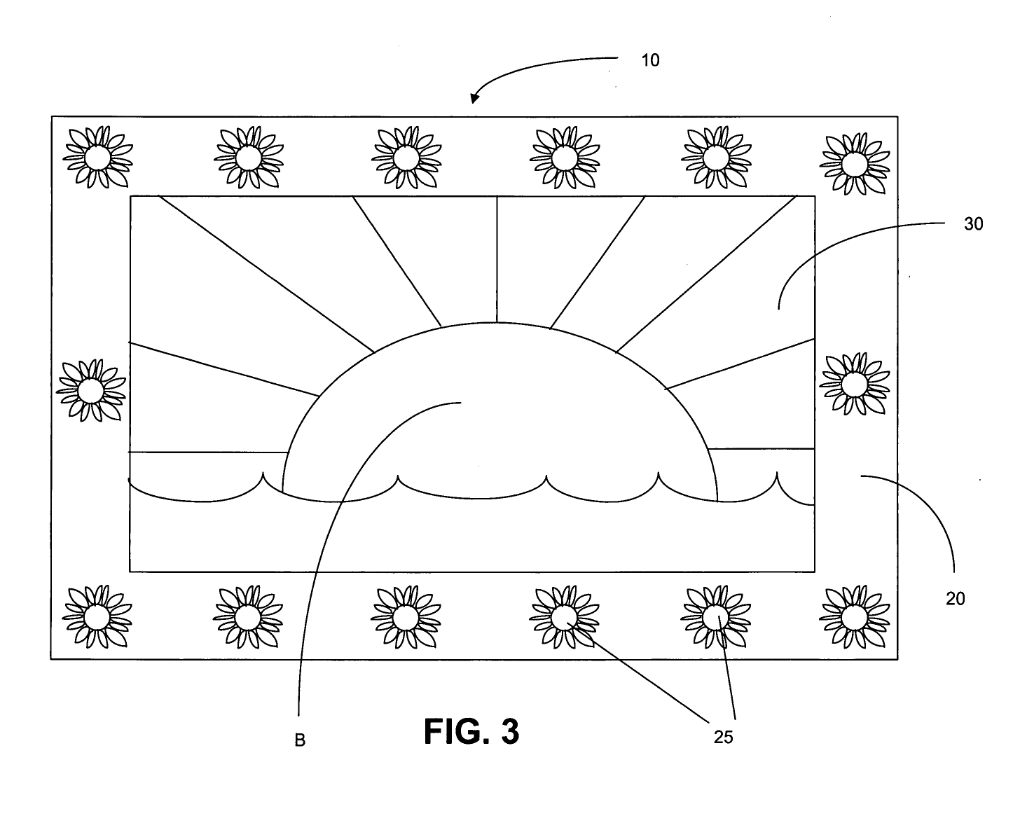

As shown in FIGS. 2 and 3, second area 30 is bordered by first area 20. Accordingly, second area 30 is adapted to receive an interchangeable doormat B (FIG. 3). A plurality of drainage conduits or holes 33 are provided in the surface of second area 30. Drainage holes 33 are visible when interchangeable doormat B is removed and are covered from view when interchangeable doormat B is in place. Drainage holes 33 allow any moisture to drain from second area 30 and away from interchangeable doormat B.

A first indicia 25 is provided within first area 20. As shown in a preferred embodiment shown in FIGS. 2 through 4, first indicia 25 is a raised three-dimensional flower pattern. First indicia 25 serves the purpose of making the first area 20 an attractive border for second area 30 and/or interchangeable doormat B. First indicia 25 also serves the functional purpose of providing a rough surface for wiping the feet when a raised three-dimensional pattern is used. A person of ordinary skill in the art will recognize that such a pattern may be molded or engraved onto the surface of area 20 and that indicia 25 may be of any shape or form.

A second indicia 35 is provided within second area 30. As with first indicia 25, second indicia 35 serves both a decorative and functional purpose when interchangeable doormat B is removed. Accordingly, border mat 10 is usable as a functional doormat when interchangeable doormat B is not present, such as when interchangeable doormat B is being cleaned, or in between changing from one interchangeable doormat to another. Second indicia 35 may be identical to first indicia 25 or may be of a different design of any shape or form.

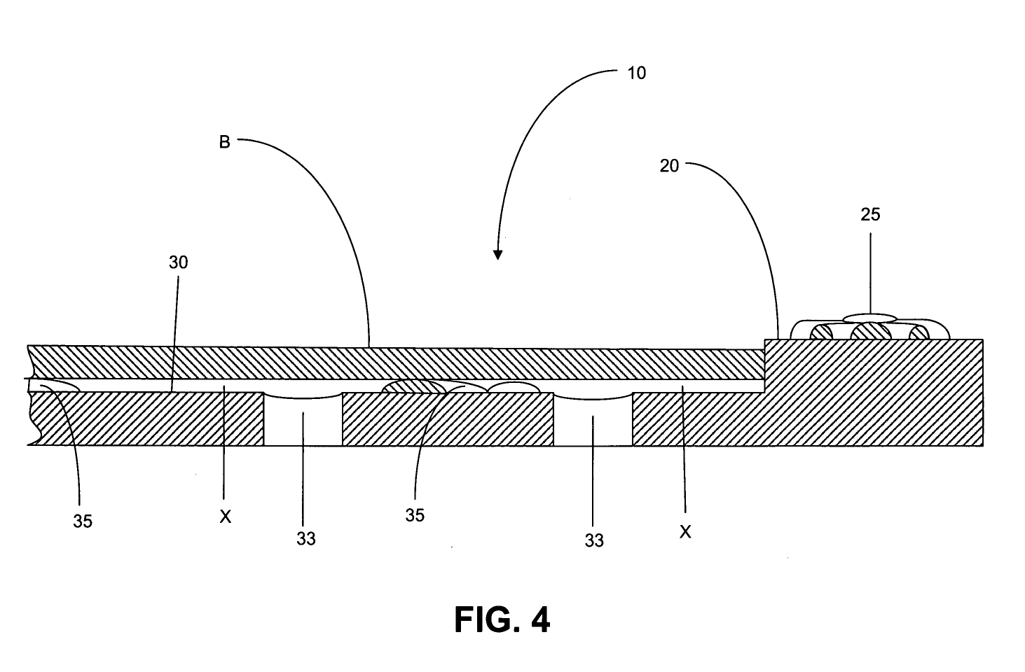

FIG. 4 illustrates a cross sectional view of the preferred embodiment shown in FIG. 3. As shown in FIG. 4, the surface of second area 30 is recessed in comparison to the surface of first area 20 which borders second area 30. Accordingly, a recessed area is provided for receiving interchangeable doormat B within second area 30. Drainage conduits 33 are provided within second area 30 forming drainage holes from the surface of second area 30 through the base of border mat 10. Drainage conduits 33 allow the drainage of any moisture that has accumulated within second area 30. Accordingly, moisture may be removed away from interchangeable doormat B prolonging the life and usefulness of both interchangeable doormat B and border mat 10.

As can be seen in FIGS. 2 and 4, second indicia 35 is a raised three-dimensional design. This raised design allows interchangeable doormat B to rest upon second indicia 35 when placed within second area 30. Such an arrangement produces an air space X between the bottom of interchangeable doormat B and the more recessed portions of the surface of second area 30. Air space X helps prevent interchangeable doormat B from coming in contact with moisture that is draining from second area 30 through drainage conduits 33 and prevents interchangeable doormat B from absorbing accumulated moisture, which helps prolong the life and usefulness of interchangeable doormat B.

Conveniently, second area 30 is dimensioned to receive a doormat of conventional size. Accordingly, second area 30 is rectangular in shape and measures 18 inches by 30 inches, which are the same dimensions as a conventional doormat. Although border mat 10 may be made of any material, it is preferably made from rubber for durability. The rubber may be natural or synthetic, and is preferably produced from recycled tires.

Accordingly, it may be seen that the embodiments of the border mats disclosed herein aid in preventing water or moisture from pooling beneath an interchangeable doormat and/or being absorbed by an interchangeable doormat. Thus, the life and usefulness of such interchangeable doormats is prolonged and their functionality is increased.

While the invention has been disclosed in preferred forms, it will be apparent to those skilled in the art that many modifications, additions, and deletions can be made therein, especially in matters of shape, size and arrangement of parts used to carry out the disclosed embodiments, without departing from the spirit and scope of the invention and its equivalents as set forth in the following claims. Therefore, other modification or embodiments as may be suggested by the teachings herein are particularly reserved especially as they fall within the breadth and scope of the claims here appended.

What is claimed is:

1. A border mat for supporting and bordering an interchangeable doormat, said border mat comprising:
a support member having a base, a surface and a periphery;
a first area carried by said surface of said support member, said first area extending around said periphery of said support member;
a second area carried by said surface of said support member and bordered by said first area, said second area adapted for receiving an interchangeable doormat;
a plurality of drainage conduits each having a periphery, said drainage conduits defining drainage holes from said second area through said base, wherein moisture is removed from said second area and away from an interchangeable doormat.

2. The border mat of claim 1, wherein said first area has a first indicia thereon.

3. The border mat of claim 2, wherein said second area has a second indicia thereon.

4. The border mat of claim 3, wherein said second indicia is the same as said first indicia.

5. The border mat of claim 2, wherein said first indicia is a raised three-dimensional pattern.

6. The border mat of claim 2, wherein said second indicia is a raised three-dimensional pattern.

7. The border mat of claim 1, wherein said second area has a rectangular shape measuring 18 inches by 30 inches to accommodate an interchangeable doormat with substantially the same dimensions.

8. The border mat of claim 1, wherein said support member is made from recycled rubber.

9. A border mat for supporting and bordering an interchangeable doormat, said border mat comprising:
a support member having a base, a surface, and a periphery;
a raised first area on said surface of said support member, said first area extending around said periphery of said support member and having a first three dimensional pattern thereon;
a recessed second area on said surface of said support member and bordered by said raised first area, said recessed second area adapted for receiving an interchangeable doormat and having a second three dimensional pattern thereon for supporting an interchangeable doormat within said recessed second area and creating an air space between the surface of said support member and an interchangeable doormat;
a plurality of drainage conduits each having a periphery, said drainage conduits defining drainage holes from said recessed second area through said base, wherein moisture is removed from said recessed second area and away from an interchangeable doormat.
